(19) United States
(12) Patent Application Publication
(10) Pub. No.: US 2022/0338483 A1
(43) Pub. Date: Oct. 27, 2022

(54) TUNNEL OVEN

(71) Applicant: Heuft Thermo-Oel GmbH & Co. KG, Bell (DE)

(72) Inventor: Christoph FÜLBIER, Bad Breisig (DE)

(21) Appl. No.: 17/730,769

(22) Filed: Apr. 27, 2022

(30) Foreign Application Priority Data
Apr. 27, 2021 (DE) 10 2021 204 166.3

(51) Int. Cl. A21B 1/26; A21B 1/46

(52) U.S. Cl. CPC A21B 1/26; A21B 1/46

(57) ABSTRACT

Tunnel oven for the industrial production of baked goods; having a baking chamber with an air-permeable, endlessly circulating conveyor belt, which is set up for conveying baked goods in a conveying direction through the baking chamber; a plurality of bottom-heat air outlet nozzles, which are arranged below the conveyor belt and are directed towards the underside of the conveyor belt, wherein the bottom-heat air outlet nozzles generate a bottom-heat inlet air flow directed directly towards the underside of the conveyor belt; a plurality of bottom-heat air inlets, which are distributed in a planar manner below the conveyor belt, in order to discharge bottom-heat exhaust air below the conveyor belt; wherein the bottom-heat exhaust air is sucked off by means of a fan and is supplied heated by thermo oil as the bottom-heat inlet air flow, so that a bottom-heat convection circuit is generated.

### 1. TECHNICAL FIELD

The present invention relates to a tunnel oven for the industrial production of baked goods. In particular, the present invention relates to a tunnel oven in which the baked goods run through the tunnel oven in a certain conveying direction on a conveyor belt. Such tunnel ovens are used in particular for baking baked goods in boxes of box assemblies, such as toasted bread.

### 2. STATE OF THE ART

In tunnel ovens, baked goods are baked, in which they run through the tunnel oven from one side to the other. Correspondingly, one also speaks of continuous baking ovens. Such tunnel ovens are generally suitable for a very large baking capacity and are dimensioned accordingly. They often have hearth widths of 2 to 4 m and hearth lengths of 10 to 60 m. Correspondingly, such tunnel ovens are also referred to as tunnel—large baking oven or industrial tunnel oven. A disadvantage of tunnel ovens is the high space requirement, in particular the large length in the running direction. Furthermore, the capital input for a continuous oven is comparatively high.

Tunnel ovens can be designed for a batch-wise, i.e. stepwise, or continuous operation. Due to the high capacities, the loading of the conveyor belt of the tunnel oven is often automated.

Decisive for the baking result is the heat input onto the baked goods. For this purpose, different solutions are known in the state of the art.

From the document DE 10 2018 208 959 A1, a continuous oven for the continuous baking operation is known, which has at least two baking chambers lying one above the other. The continuous oven has in each case a thermo-oil pipe heat exchanger in the baking chamber for the top and bottom heat. With a circulating air device, a baking chamber heating via a radiation emission from the thermo-oil heat exchanger can be combined with the advantages of a convective heat transfer.

From the document DE 10 2016 223 041 A1, a continuous oven is known, which has a first air-permeable heating element below a conveyor belt and a second air-permeable heating element above the conveyor belt. The heating elements can be configured as thermo-oil-heated heating plates with passage openings. Furthermore, air-guiding devices with adjustable air passage openings are provided, in order to flow against the two heating elements in a targeted manner.

From the document EP 2 870 876 B1, a continuous oven is known, in which a heating register is arranged below a conveyor belt, which consists of a planar arrangement of a pipe through which thermo oil flows. The heating register is flowed through from below with air, which then impinges from below on the conveyor belt and on the baked goods. In order to flow against the heating register, an air-guiding device is further present in a register lower space, in order to blow the tubes of the register directly.

From the document EP 3 358 975 B1, a continuous oven with combined heat transfer and at least three baking zones is known, in which each of the baking zones has at least one means for convection heating of the lower side and the upper side of the baked goods and additionally a heat exchanger plate for radiation heating of the upper side and/or lower side of the baked goods.

Although the state of the art shows a variety of possibilities for heating a tunnel oven, there is a need to further improve the efficiency of the tunnel oven and the baking result, in particular for baked products in boxes or moulds, such as toasted bread.

### 3. SUMMARY OF THE INVENTION

The above-mentioned object is achieved by a continuous oven according to claim 1.

In particular, the object is achieved by a tunnel oven for the industrial production of baked goods; having a baking chamber with an air-permeable, endlessly circulating conveyor belt, which is configured to convey baked goods or baked goods in a conveying direction through the baking chamber; a plurality of bottom-heat air outlet nozzles, which are arranged below the conveyor belt and are directed towards the underside of the conveyor belt, wherein the bottom-heat air outlet nozzles generate a bottom-heat inlet air flow directed directly towards the underside of the conveyor belt; a plurality of bottom-heat air inlets, which are distributed in a planar manner below the conveyor belt, in order to discharge bottom-heat exhaust air below the conveyor belt; wherein the bottom-heat exhaust air is sucked off by means of a fan and is supplied heated by thermo oil as the bottom-heat inlet air flow, so that a bottom-heat convection circuit is generated.

By means of a plurality of bottom-heat air outlet nozzles, a bottom-heat inlet air flow directed directly towards the underside of the conveyor belt is generated, which generates an optimal heat input onto the baked goods, in particular onto baked goods in boxes, moulds and box assemblies. By means of the direct bottom-heat inlet air flow, the heat input can be precisely regulated here and a very uniform and high heat input onto the baked goods is possible. The direct bottom-heat inlet air flow can thereby achieve a flow velocity of up to 20 m/s in the nozzle gap. By means of the directed bottom-heat inlet air flow, the side walls of boxes, moulds and box assemblies are also convectively heated, so that the baked goods are heated uniformly.

By means of the simultaneous supply of the directed bottom-heat inlet air flow and the planar suction of the bottom-heat exhaust air in each case from below the conveyor belt, i.e. below the baked goods, a vertical turbulence of the convection flow results, which greatly increases the heat transfer of the convection flow onto the baked goods in comparison to a laminar flow. By means of the planar discharge of the bottom-heat exhaust air by means of the plurality of bottom-heat air inlets, a constantly high vertical turbulence over the entire hearth area is achieved, so that the convective heat input of the bottom heat is uniform despite the very large hearth width and length. In addition, by means of the simultaneous supply and discharge of the convection air below the conveyor belt and the bottom-heat convection circuit, the bottom heat of the tunnel oven can be regulated independently of a possibly present top-heat convection, which is particularly advantageous in the case of the very high heat input by means of the bottom-heat convection. Here, the bottom heat and the top heat have hardly any influence on themselves. In particular, the tunnel oven can thus be operated in such a way that the baked goods experience only little convection flow on its upper side and excessive drying out on the upper side is thereby prevented. In addition, the heat input can be regulated via an optional top-heat convection in a manner substantially uninfluenced by the heat input of the bottom heat.

Furthermore, by means of the simultaneous supply of the directed bottom-heat inlet air flow and the planar suction of the bottom-heat exhaust air in each case from below the conveyor belt, also sheet metal goods can be baked on an industrial scale. In the case of baked goods on sheets, the air-impermeable sheet metal substantially separates the air space below the sheet metal from the air space above the sheet metal. In particular, by means of the plurality of bottom-heat air inlets distributed in a planar manner, high air quantities can nevertheless likewise be used in the case of sheet metal goods, in order to achieve high but uniform heat inputs onto the baked goods. A flow through the entire baking chamber from bottom to top or from top to bottom is not necessary.

By means of the heating of the bottom-heat inlet air flow by means of thermo oil, a consistently high temperature of the bottom-heat inlet air flow is achieved, even if a very high heat requirement exists. Here, by means of the thermo oil as heat transfer medium, the location of the heat generation can be separated from the tunnel oven and can be provided for instance as a separate thermo oil heating center. This reduces the space requirement of the tunnel oven itself and optimizes the heat generation.

Preferably, the bottom-heat air outlet nozzles are designed to be linear at least in sections and/or extend substantially over the entire width of the conveyor belt. Thus, a uniform flow against and heating of the baked goods is achieved over the entire width of the conveyor belt.

Preferably, the bottom-heat air outlet nozzles and the bottom-heat air inlets are arranged substantially on the same plane below the conveyor belt. Thus, the most uniform suction possible of the bottom-heat exhaust air is conveyed further over the entire area of the baking chamber, so that the heat input onto the baked goods is as uniform as possible, even in the case of large baking chamber widths and lengths.

Preferably, the tunnel oven further has at least one thermo-oil-air heat exchanger arranged outside the baking chamber, which is configured to heat the bottom-heat exhaust air sucked off via the bottom-heat air inlets and to supply it to the bottom-heat air outlet nozzles as bottom-heat inlet air. Via the thermo-oil-air heat exchanger arranged outside the baking chamber, the bottom-heat inlet air can be heated precisely, without additionally introducing an indeterminate heat input into the baking chamber, as is the case with heat exchanger tubes in the baking chamber.

Preferably, the tunnel oven further has a plurality of bottom-heat air outlet channels formed in a channel-like manner, which are arranged below the conveyor belt and transversely to the conveying direction, for supplying inlet air to the bottom-heat air outlet nozzles; and/or a plurality of bottom-heat air suction channels formed in a channel-like manner, which are arranged below the conveyor belt and transversely to the conveying direction, for discharging exhaust air from the bottom-heat air inlets.

Preferably, the bottom-heat air outlet channels and the bottom-heat air suction channels are arranged in an alternating manner in the conveying direction.

Thus, a uniform heating of the baked goods by bottom-heat convection is ensured.

Preferably, the bottom-heat air outlet channels have a trapezoidal cross section, which narrows from bottom to top; and/or the bottom-heat air suction channels have a trapezoidal cross section, which widens from bottom to top; and/or two adjacent bottom-heat air outlet and bottom-heat air suction channels each have a common intermediate wall arranged in an inclined manner. These cross sections optimize the directed supply and planar suction of the bottom-heat convection flow.

Preferably, the baking chamber below the baked goods is heated substantially by means of convection. The heat input by convection is very effective, so that an additional heat input via radiation can be dispensed with.

Alternatively to a pure convection, the tunnel oven preferably furthermore has a plurality of bottom-heat thermo-oil heating tubes, which are arranged below the conveyor belt. Although the heat input onto the baked goods by thermal radiation by means of thermo-oil heating tubes is not as effective as the heat input by convection, it adds up to the convection.

Preferably, the bottom-heat thermo-oil heating tubes are flowed through from top to bottom with bottom-heat exhaust air, wherein between the bottom-heat thermo-oil heating tubes bottom-heat air inlets are formed. Since the bottom-heat thermo-oil heating tubes are flowed through from top to bottom with bottom-heat exhaust air, the latter heats up and is available as bottom-heat inlet air, which is blown onto the baked goods in a defined manner via the bottom-heat air outlet nozzles and preferably with a high flow velocity directly from below.

Preferably, the tunnel oven further comprises a plurality of top-heat air outlet nozzles, which are arranged above the conveyor belt in the upper region of the baking chamber and are directed towards the upper side of the conveyor belt, wherein the top-heat air outlet nozzles generate a top-heat inlet air flow directed directly towards the upper side of the conveyor belt; and a plurality of top-heat air inlets, which are distributed in a planar manner above the conveyor belt, to discharge top-heat exhaust air in a planar manner above the conveyor belt; wherein the top-heat exhaust air is mechanically sucked off and supplied as the top-heat inlet air flow, so that a top-heat convection circuit is generated. Optionally, the tunnel oven can also have convection heating for the top heat. This is advantageous in particular when baked goods are baked in closed baking moulds or closed box assemblies, such as toasted bread. Then, the heat input onto the baked goods can be increased further by a top-heat convection circuit. The heat input by the top-heat convection is substantially independent of the heat input by the bottom heat by the supply and discharge of the top-heat convection air above the conveyor belt and thus above the baked goods. Simulations have shown that, as a result of the type of air conduction and the separate convection circuits, the air flows of the bottom heat hardly mix with the air flows of the top heat and thus also the heat inputs of the convection onto the underside or top side of the baked goods hardly influence themselves. Thus, the top and bottom-heat convection are regulatable substantially independently of one another.

Preferably, the tunnel oven further has a plurality of top-heat thermo-oil heating tubes, which are arranged in the upper region of the baking chamber. Additionally or alternatively to a top-heat convection, a heating of the baked goods can also take place by means of thermal radiation, which are arranged by top-heat thermo-oil heating tubes in the upper region of the baking chamber. Although the heat input onto the baked goods by thermal radiation by means of thermo-oil heating tubes is not as effective as the heat input by convection, the drying out of the baked goods is lower in the case of the thermal radiation, so that the finished baked goods have more moisture. As a result, sheet metal goods with a high heat input and at the same time low drying out can be baked particularly advantageously. As a result of the sheet metal, the baked goods cannot dry out from below, but at the top it is unprotected, so that it is advantageous to bake with a higher radiation proportion in the top heat. When baking sheet metal goods, the sheet metal furthermore advantageously separates the strong convection of the bottom heat from the region of the top heat, in which only a low convection then occurs.

Preferably, the top-heat thermo-oil heating tubes are flowed through from bottom to top with top-heat exhaust air. Here, the flowing-through top-heat exhaust air heats up and is available as top-heat inlet air, which is blown onto the baked goods directly from above via the top-heat air outlet nozzles.

Preferably, the bottom-heat and/or the thermo-oil heating tubes are formed as ribbed tubes or smooth tubes. The ribs of the ribbed tubes enlarge the surface thereof and ensure a better heat transfer to flowing-through convection air. Smooth tubes, on the other hand, have a better heat output by radiation than ribbed tubes.

Preferably, the top-heat air outlet nozzles are designed to be linear at least in sections and/or extend substantially over the entire width of the conveyor belt. Thus, the top-heat convection is blown onto the baked goods in a linear manner, so that they are heated as effectively as possible and at the same time uniformly.

Preferably, tunnel oven further has a thermo-oil heating boiler, configured to heat thermo oil for the at least one thermo-oil-air heat exchanger and/or configured to heat the plurality of top-heat and/or bottom-heat thermo-oil heating tubes.

Preferably, the width of the conveyor belt is at most 4 m, preferably 2-4 m, particularly preferably 3-4 m and in particular 2 m, 2.5 m, 3 m, 3.5 m, 4 m.

Preferably, the length of the tunnel oven is at most 50 m, preferably 10 to 30 m, particularly preferably 10 to 20 m.

### 4. BRIEF DESCRIPTION OF THE FIGURES

In the following, preferred embodiments of the present invention are illustrated by means of the attached figures. In the figures:

FIG. 1 a schematic cross-sectional view of a first embodiment of a tunnel oven with heating by bottom-heat convection;

FIG. 2 a schematic horizontal partial sectional view from above of the embodiment of FIG. 1;

FIG. 3 a schematic cross-sectional view of a detail of the embodiment of FIG. 1;

FIG. 4 a schematic three-dimensional sectional view of bottom-heat air outlet channels and bottom-heat air suction channels of the embodiment of FIG. 1

FIG. 5 a schematic cross-sectional view of a bottom-heat air outlet channel of the embodiment of FIG. 1;

FIG. 6 a schematic cross-sectional view of a second embodiment of a tunnel oven with heating by bottom-heat convection, top-heat convection and top-heat radiation;

FIG. 7 a schematic cross-sectional view of a third embodiment of a tunnel oven with heating by bottom-heat convection, bottom-heat radiation, top-heat convection and top-heat radiation;

FIG. 8 a diagram of the heat flow densities at a baked goods in box form in dependence on the nozzle outflow velocity of the bottom-heat convection; and

FIG. 9 a diagram of the heat flow densities at a baked goods in box form in dependence on the nozzle outflow velocity of the top-heat convection.

### 5. DETAILED DESCRIPTION OF PREFERRED EMBODIMENTS

In the following, preferred embodiments of the present invention are described in detail with reference to the attached figures.

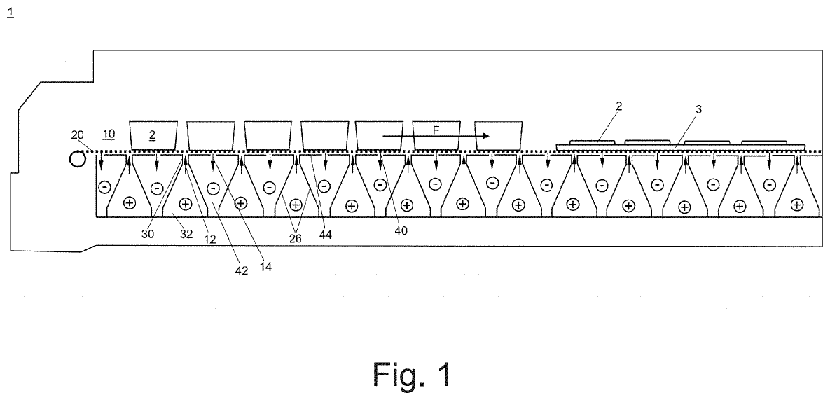

FIGS. 1 to 5 show a first embodiment of a tunnel oven 1, in which the heating of the baking chamber 10 takes place substantially by bottom-heat convection. The tunnel oven 1 has an air-permeable conveyor belt 20, on which the baked goods 2 to be baked are conveyed in the conveying direction F through the baking chamber 10. Preferably, the length of the tunnel oven 1 is at most 50 m, preferably 10 to 30 m, particularly preferably 10 to 20 m.

The conveyor belt 20 is endlessly circulating and has an upper run, which moves in the conveying direction F, and a lower run, which moves counter to the conveying direction F, and which is not shown for simplification purposes. When the conveyor belt 20 is mentioned in the following, reference is made to the upper run, on which the baked goods 2 are deposited.

The baked goods 2 can lie freely on the conveyor belt 20 or, which is preferred, can be arranged in moulds, boxes or box assemblies. The boxes or box assemblies can be closed with a lid, as is the case, for example, for baking toasted bread.

As shown in FIG. 1, the baked goods 2 can also be baked as so-called sheet metal goods on baking sheets 3.

Preferably, the width of the conveyor belt 20 is at most 4 m, preferably 2-4 m, particularly preferably 3-4 m and in particular 2 m, 2.5 m, 3 m, 3.5 m, 4 m.

A plurality of bottom-heat air outlet channels 32, which preferably have a trapezoidal cross section, which narrows from bottom to top, are arranged below the conveyor belt 20. A plurality of bottom-heat air suction channels 42, which preferably have a trapezoidal cross section, which widens from bottom to top, are arranged in an alternating manner in between. Preferably, two adjacent bottom-heat air outlet and bottom-heat air suction channels 32, 42 each have a common intermediate wall 26 arranged in an inclined manner. Thus, the bottom-heat air outlet and bottom-heat air suction channels 32, 42 can be produced in a material-saving manner in particular from sheet metal.

The bottom-heat air outlet channels 32 each form on the upper side bottom-heat air outlet nozzles 30, 80, which are arranged below the conveyor belt 20 and are directed towards the underside of the conveyor belt 20. Thus, the bottom-heat air outlet nozzles 30, 80 can generate a bottom-heat inlet air flow 12 directed directly towards the underside of the conveyor belt 20.

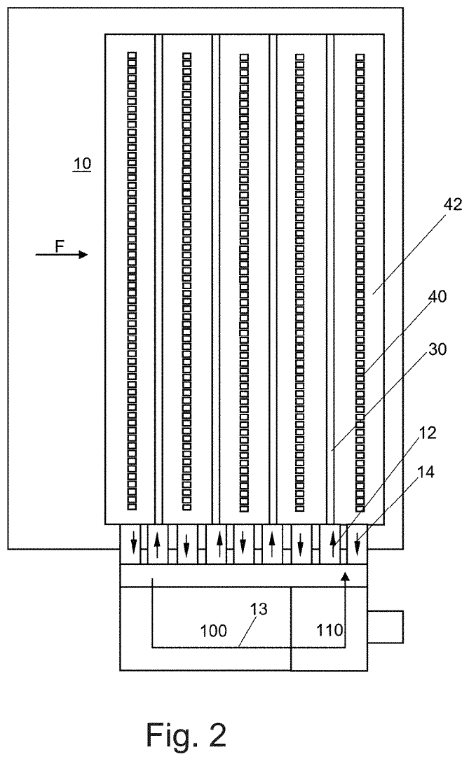

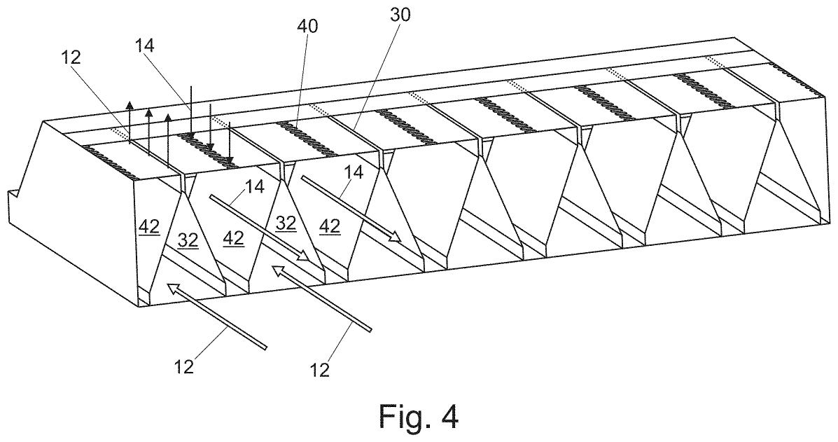

As can be seen in FIG. 2, the bottom-heat air outlet nozzles 30 are designed to be linear and extend substantially over the entire width of the conveyor belt 20. Thus, the baked goods are blown in a linear manner from below with a strong, directed air flow 12. The velocity of the air flow 12 in the nozzle gap of the bottom-heat air outlet nozzles 30 can be up to 20 m/s. As can be seen in FIG. 5, the width b_{D} of the nozzle gap is preferably 5 mm to 15 mm, particularly preferably 8 mm.

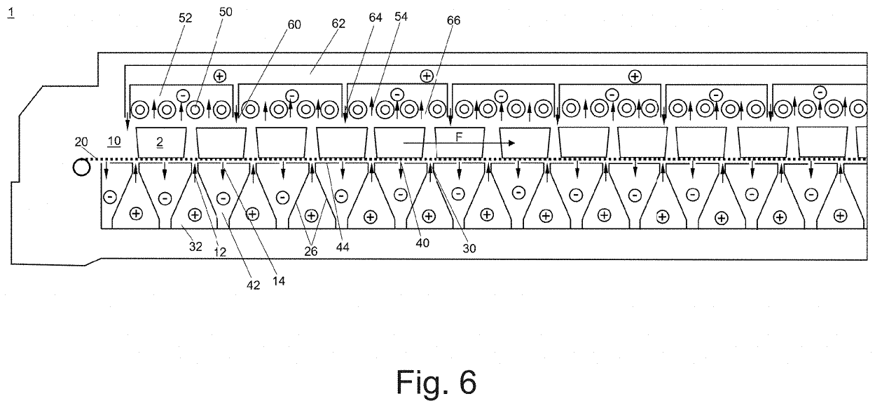

The bottom-heat air suction channels 42 each have on their upper side bottom-heat air inlets 40, which are distributed in a planar manner below the conveyor belt 20, to discharge bottom-heat exhaust air 14 below the conveyor belt 20. As can be seen in FIG. 2 and FIG. 4, the bottom-heat air inlets 40 can consist of a series of individual openings. However, other configurations of the bottom-heat air inlets 40 are likewise possible.

As illustrated in FIG. 2, the bottom-heat exhaust air 14 is mechanically sucked off from the baking chamber 10 by means of a fan 110 and supplied again as bottom-heat inlet air flow 12 to the baking chamber 10, so that a bottom-heat convection circuit 13 is generated. The positive pressure in the bottom-heat air outlet channels 32 is symbolized by a “+” sign, the negative pressure in the bottom-heat air inlet channels 42 by a “−” sign.

In the bottom-heat convection circuit 13 there is a thermo-oil-air heat exchanger 100, which heats the bottom-heat exhaust air 14 to the desired blow-in temperature. The thermo-oil-air heat exchanger 100 is heated by means of thermo oil, which is heated by a heating boiler (not illustrated).

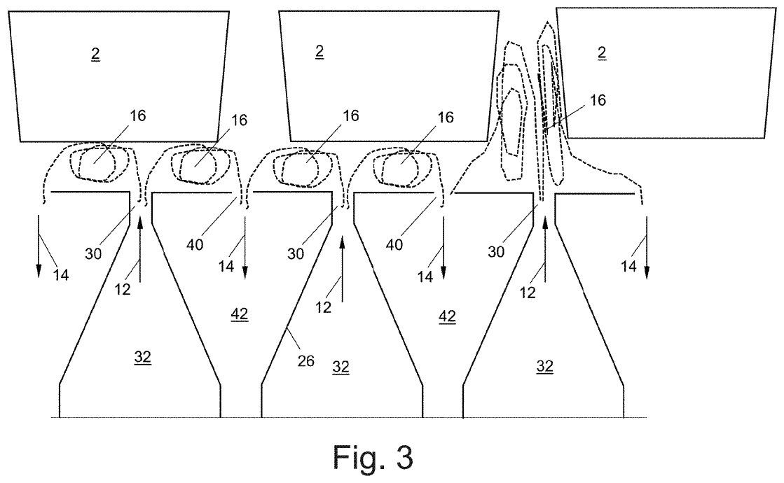

As a result of the blowing in of the bottom-heat inlet air flow 12 from below onto the baked goods 12 and the planar suction of the bottom-heat exhaust air 14 likewise from below the baked goods 12, a bottom-heat vertical turbulence 16 is generated, as is illustrated in a greatly simplified manner in FIG. 3. As illustrated in the right-hand region of FIG. 3, the bottom-heat vertical turbulence 16 can also extend into the region between parts of the baked goods 2, i.e. between the moulds, boxes or parts of box assemblies, and can heat the side walls thereof. A complete flow through the baking chamber 10 also into the region of the top heat is however neither necessary nor desired. The bottom-heat vertical turbulence 16 in this case brings about a strong heat transfer between the convection air 12, 16 and the baked goods 12. This turbulent heat transfer is substantially higher than in the case of a purely laminar flow of the convection air 12, 16 along the baked goods 12. Correspondingly, either the tunnel oven 1 can be designed to be shorter than comparable tunnel ovens, or the throughput through the tunnel oven 1 can be increased.

By virtue of the fact that the bottom-heat vertical turbulence 16 substantially only influences the bottom heat, the top heat of the tunnel oven can be configured as required.

In the first embodiment of FIG. 1, no top heat is provided, and the baking chamber is heated substantially exclusively by the bottom-heat vertical turbulence 16. This has the advantage of a high heat input by bottom-heat convection onto the baking moulds, boxes or baking sheets 3, without the baked goods drying out excessively.

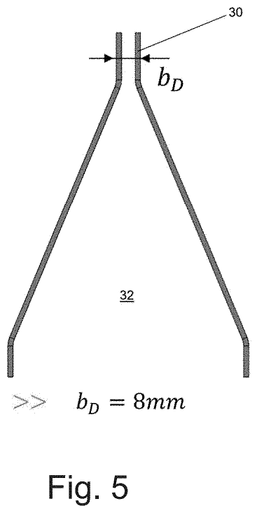

FIG. 6 shows a second embodiment of the tunnel oven 1, which corresponds in respect of the bottom heat to the first embodiment of FIG. 1 and which additionally has a heating of the baking chamber 1 with top heat.

For this purpose, a plurality of top-heat air outlet nozzles 60, which are directed towards the upper side of the conveyor belt 20, are arranged above the baked goods 2, i.e. in the upper region of the baking chamber 10. These top-heat air outlet nozzles 60 generate a top-heat inlet air flow 64 directed directly towards the upper side of the conveyor belt 20.

Furthermore, the second embodiment of the tunnel oven 1 has a plurality of top-heat air inlets 66, which are distributed in a planar manner above the conveyor belt 20, to discharge top-heat exhaust air 54 in a planar manner above the conveyor belt 20. The top-heat exhaust air 54 is mechanically sucked off, for example, by means of a fan (not illustrated) and supplied as the top-heat inlet air flow 64. Here, a top-heat convection circuit is generated, in which the top-heat air is guided substantially in a circle and a top-heat vertical turbulence is generated, which substantially heats the upper sides of the baked goods 2 by convection. The corresponding pressure differences of the top-heat convection are likewise symbolized by “+” and “−” signs.

The top heat further optionally has a plurality of top-heat thermo-oil heating tubes 50, which are likewise arranged in the upper region of the baking chamber 10. These top-heat thermo-oil heating tubes 50 emit a thermal radiation onto the baked goods 2 from above, on the one hand, and on the other hand they heat the top-heat exhaust air 54, which flows through the top-heat thermo-oil heating tubes 50 from bottom to top. Here, the space between the top-heat thermo-oil heating tubes 50 forms the top-heat air inlets 66. Above the top-heat thermo-oil heating tubes 50 there are top-heat air suction channels 52, which open into the fan of the top heat. The top-heat inlet air is guided from the fan via top-heat inlet air distributors 62 to the top-heat air outlet nozzles 60.

The top-heat thermo-oil heating tubes 50 are preferably formed as smooth tubes, in order to improve the heat input via radiation. This is advantageous in particular when baking in the top heat predominantly with radiant heat and less with convection, for instance in order to prevent excessive drying out of the baked goods.

If, on the other hand, a heating of the top-heat convection air is in the foreground, the top-heat thermo-oil heating tubes 50 can also be formed as ribbed tubes, in order to enlarge the surface thereof. Thus, the heat transfer onto the top-heat exhaust air 54 flowing through is increased and thermal radiation is also emitted onto the baked goods 2.

Alternatively to the top-heat thermo-oil heating tubes 50, the top heat can also be designed purely as convection, wherein the top-heat exhaust air 54 is either not additionally heated at all or wherein the top-heat exhaust air 54 is heated similarly to the bottom heat by a thermo-oil-air heat exchanger, which is located outside the baking chamber.

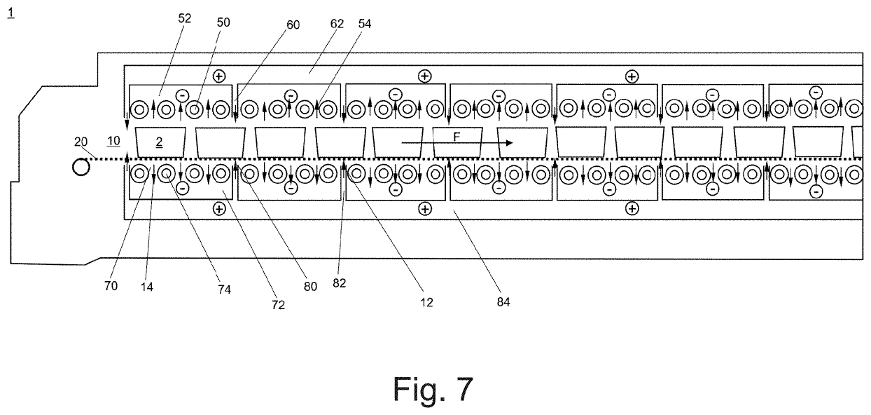

FIG. 7 shows a third embodiment of the tunnel oven 1, which corresponds in respect of the top heat to the second embodiment of FIG. 6 and which has a bottom heat which structurally corresponds to the top heat of the second embodiment of FIG. 6, merely with reversed flow directions. In the third embodiment, the baked goods 2 are heated in addition to the top heat by means of a bottom-heat convection and a bottom-heat radiation.

In this third embodiment of the tunnel oven 1, a plurality of bottom-heat thermo-oil heating tubes 74 are arranged below the conveyor belt 20. These are flowed through from top to bottom with bottom-heat exhaust air 76. The bottom-heat thermo-oil heating tubes 74 therefore form between them bottom-heat air inlets 70. The bottom-heat thermo-oil heating tubes 74 are preferably formed as smooth tubes in order to optimize the emitted thermal radiation. However, they can likewise be formed as ribbed tubes in order to enlarge the surface thereof.

Between the bottom-heat thermo-oil heating tubes 74, bottom-heat air outlet nozzles 80 are arranged, which generate a bottom-heat inlet air flow 12 directed directly towards the underside of the conveyor belt 20. Preferably, these bottom-heat air outlet nozzles 80 are designed to be linear and extend transversely over substantially the entire width of the conveyor belt 20. The bottom-heat exhaust air 76 is mechanically sucked off by bottom-heat air inlets 70 between the bottom-heat thermo-oil heating tubes 74 by means of a fan (not illustrated), which is symbolized by the “−” sign. Here, the bottom-heat thermo-oil heating tubes 74 heat the bottom-heat exhaust air 76. Below the bottom-heat thermo-oil heating tubes 74 there are bottom-heat exhaust air collectors 72, which open into the fan of the bottom heat. From the fan, the bottom-heat inlet air 12 is guided via bottom-heat inlet air distributors 84 to bottom-heat air outlet channels 82, which open into the bottom-heat air outlet nozzles 80.

Corresponding to the first and second embodiment, the bottom-heat air outlet nozzles 80 are arranged below the conveyor belt 20 and are directed towards the underside of the conveyor belt 20, wherein they generate a bottom-heat inlet air flow 12 directed directly towards the underside of the conveyor belt 20. By means of the bottom-heat inlet air flow 12 and the suction of the bottom-heat exhaust air 14, a bottom-heat vertical turbulence also arises in this third embodiment, which brings about the main part of the heat input onto the baked goods 2. In addition, the bottom-heat thermo-oil heating tubes 74 radiate upwards and heat the underside of the baked goods 2 by thermal radiation.

By virtue of the fact that the supply and suction of the convection air for the top heat and the bottom heat are separated from one another, an individual regulation of the convection of the bottom and top heat is possible. Thus, for example, the air throughput, the air speed and the air temperature for bottom and top heat can be set individually from one another, in order, for example, to provide a substantially higher convection heat input by the bottom heat than by the top heat. The baking result can thus be improved.

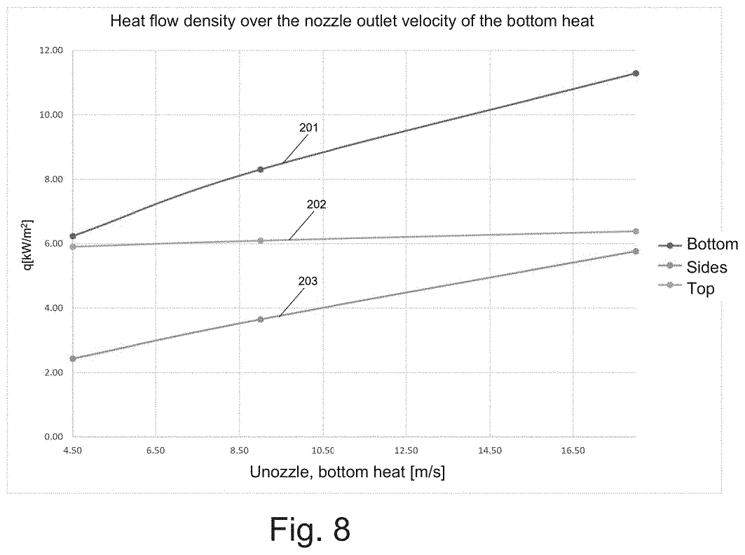

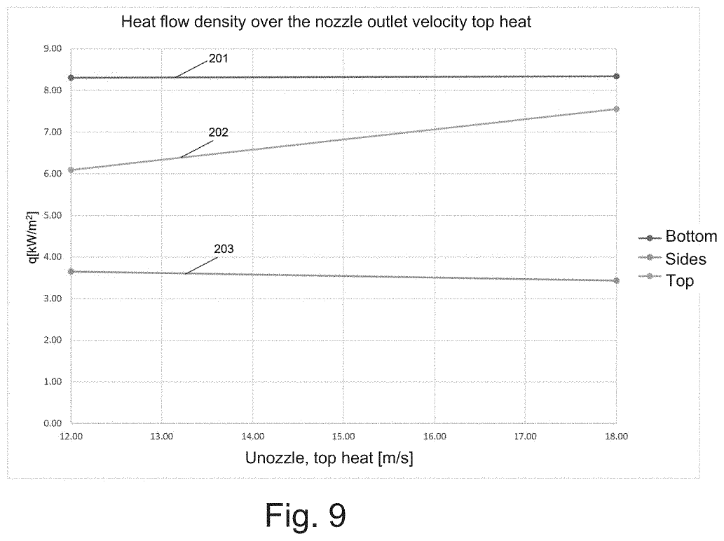

The FIGS. 8 and 9 show diagrams of the heat flow densities at a baked goods, which is baked in a box form, in dependence on the nozzle outflow velocities of the bottom-heat and top-heat convection. The diagrams were created within the scope of flow simulations of an exemplary tunnel oven 1 according to the embodiment of FIG. 6.

The graph 201 shows the heat flow density onto the underside of the baked goods 2, the graph 202 shows the heat flow density onto the upper side of the baked goods 2 and the graph 203 shows the heat flow density onto the side surfaces of the baked goods 2.

In the diagram of FIG. 8, the nozzle outflow velocity of the top-heat convection is kept constant at 12 m/s and the nozzle outflow velocity of the bottom-heat convection is varied from 4.5 m/s to 18 m/s. It can be seen from the graph 201 that the heat flow density onto the underside of the baked goods increases with the nozzle outflow velocity of the bottom-heat convection from approximately 6.2 kW/m²to approximately 11.2 kW/m². At the side surfaces, the heat flow density increases from approximately 2.4 kW/m² to 5.8 kW/m², as can be seen in graph 203. Graph 202, on the other hand, shows that for the upper side of the baked goods, the heat flow density is quasi constant (minimum increase from 5.9 kW/m² to 6.4 kW/m²).

In the diagram of FIG. 9, the nozzle outflow velocity of the bottom-heat convection is now kept constant at 9 m/s and the nozzle outflow velocity of the top-heat convection is varied from 12 m/s to 18 m/s. It can be seen from the graph 202 that the heat flow density onto the upper side of the baked goods increases with the nozzle outflow velocity of the bottom-heat convection from approximately 6.1 kW/m² to approximately 7.6 kW/m². Graph 203 shows that the heat flow density at the side surfaces is quasi constant (minimum decrease from 3.7 kW/m² to 3.4 kW/m²). At graph 201, it can be seen that the heat flow density remains constant at approximately 8.3 kW/m².

The flow simulations of the diagrams of the FIGS. 8 and 9 show that an independent regulation of bottom-heat convection and top-heat convection is possible by means of the particular air guidance with a separation of bottom-heat and top-heat vertical turbulence, even at very high nozzle outflow velocities and associated very high heat flow densities at the baked goods.

### THE LIST OF REFERENCE NUMBERS

1 Tunnel oven

2 Baked goods/baked good

3 Baking sheet

10 Baking chamber

12 Bottom-heat inlet air flow

13 Bottom-heat convection circuit

16 Bottom-heat vertical turbulence

14 Bottom-heat exhaust air

20 Conveyor belt

26 Intermediate wall

30, 80 Bottom-heat air outlet nozzles

32, 82 Bottom-heat air outlet channels

40, 70 Bottom-heat air inlets

42, 72 Bottom-heat air suction channels

50 Top-heat thermo-oil heating tubes

52 Top-heat air suction channels

54 Top-heat exhaust air

60 Top-heat air outlet nozzles

62 Top-heat inlet air distributors

64 Top-heat inlet air flow

66 Top-heat air inlets

74 Bottom-heat thermo-oil heating tubes

84 Bottom-heat inlet air distributors

100 Thermo-oil-air heat exchanger

110 fan

201 Graph for heat flow density at underside of the baked goods

202 Graph for heat flow density at upper side of the baked goods

203 Graph for heat flow density at side surfaces of the baked goods

1. Tunnel oven for the industrial production of baked goods; having
a. a baking chamber with an air-permeable, endlessly circulating conveyor belt, which is configured to convey baked goods in a conveying direction through the baking chamber;
b. a plurality of bottom-heat air outlet nozzles, which are arranged below the conveyor belt and are directed towards the underside of the conveyor belt, wherein the bottom-heat air outlet nozzles generate a bottom-heat inlet air flow directed directly towards the underside of the conveyor belt;
c. a plurality of bottom-heat air inlets, which are distributed in a planar manner below the conveyor belt, to discharge bottom-heat exhaust air below the conveyor belt; wherein
d. the bottom-heat exhaust air is sucked off by means of a fan and is supplied heated by thermo oil as the bottom-heat inlet air flow, so that a bottom-heat convection circuit is generated.

2. Tunnel oven according to claim 1, wherein the bottom-heat air outlet nozzles are designed to be linear at least in sections and/or extend substantially over the entire width of the conveyor belt.

3. Tunnel oven according to claim 1, wherein the bottom-heat air outlet nozzles and the bottom-heat air inlets are arranged substantially on the same plane below the conveyor belt.

4. Tunnel oven according to claim 1, further comprising at least one thermo oil-air heat exchanger arranged outside the baking chamber, which is configured to heat the bottom-heat exhaust air sucked off via the bottom-heat air inlets and to supply it to the bottom-heat air outlet nozzles as bottom-heat inlet air.

5. Tunnel oven according to claim 1, further having
a plurality of bottom-heat air outlet channels formed in a channel-like manner, which are arranged below the conveyor belt and transversely to the conveying direction, for supplying inlet air to the bottom-heat air outlet nozzles; and/or
a plurality of bottom-heat air suction channels formed in a channel-like manner, which are arranged below the conveyor belt and transversely to the conveying direction, for discharging exhaust air from the bottom-heat air inlets.

6. Tunnel oven according to claim 5, wherein the bottom-heat air outlet channels and the bottom-heat air suction channels are arranged in an alternating manner in the conveying direction.

7. Tunnel oven according to claim 5, wherein
the bottom-heat air outlet channels have a trapezoidal cross section, which narrows from bottom to top; and/or
the bottom-heat air suction channels have a trapezoidal cross section, which widens from bottom to top; and/or
two adjacent bottom-heat air outlet and bottom-heat air suction channels each have a common intermediate wall arranged in an inclined manner.

8. Tunnel oven according to claim 1, wherein the baking chamber below the baked goods is heated substantially by means of convection.

9. Tunnel oven according to claim 1, furthermore having a plurality of bottom-heat thermo-oil heating tubes, which are arranged below the conveyor belt, wherein the bottom-heat thermo-oil heating tubes are flowed through from top to bottom with bottom-heat exhaust air, and wherein between the bottom-heat thermo-oil heating tubes bottom-heat air inlets are formed.

10. Tunnel oven according to claim 1; further having:
a plurality of top-heat air outlet nozzles, which are arranged above the conveyor belt in the upper region of the baking chamber, and are directed towards the upper side of the conveyor belt, wherein the top-heat air outlet nozzles generate a top-heat inlet air flow directed directly towards the upper side of the conveyor belt; and
a plurality of top-heat air inlets, which are distributed in a planar manner above the conveyor belt, to discharge top-heat exhaust air in a planar manner above the conveyor belt; wherein
the top-heat exhaust air is mechanically sucked off and supplied as the top-heat inlet air flow, so that a top-heat convection circuit is generated.

11. Tunnel oven according to claim 1, further having a plurality of top-heat thermo-oil heating tubes, which are arranged in the upper region of the baking chamber.

12. Tunnel oven according to claim 10, wherein top-heat exhaust air flows through the top-heat thermo-oil heating tubes from bottom to top.

13. Tunnel oven according to claim 10, wherein the top-heat air outlet nozzles are designed to be linear at least in sections and/or extend substantially over the entire width of the conveyor belt.

14. Tunnel oven according to claim 1, further having a thermo-oil heating boiler, configured to heat thermo oil for the at least one thermo-oil-air heat exchanger and/or configured to heat the plurality of top-heat and/or bottom-heat thermo-oil heating tubes.

15. Tunnel oven according to claim 1, wherein
the width of the conveyor belt is at least 2 m and/or at most 4 m, preferably 3 to 4 m, and in particular 2 m, 2.5 m, 3 m, 3.5 m, 4 m and/or
the length of the tunnel oven is at least 10 m and/or at most 50 m, preferably 10 to 30 m, particularly preferably 10 to 20 m.
